(19) United States
(12) Patent Application Publication
(10) Pub. No.: US 2014/0244126 A1
(43) Pub. Date: Aug. 28, 2014

(54) ELECTRONIC PARKING BRAKE FOR A VEHICLE

(71) Applicant: Hyundai Motor Company, Seoul (KR)

(72) Inventors: Jaehyuk Lee, Seoul (KR); Tae Hyung Lee, Gunpo (KR)

(73) Assignee: Hyundai Motor Company, Seoul (KR)

(21) Appl. No.: 14/096,351

(22) Filed: Dec. 4, 2013

(30) Foreign Application Priority Data
Feb. 27, 2013 (KR) 10-2013-0021300

(51) Int. Cl. B60T 7/12

(52) U.S. Cl. CPC B60T 7/12
USPC 701/70; 192/219.4

(57) ABSTRACT

An electronic parking brake for vehicle is provided that includes a movement detecting sensor that is configured to detect a movement of a vehicle once the vehicle is turned off. In particular, a controller is configure to determine whether the vehicle is on or off, and in response to determining that the vehicle is turned off, power is supplied to a sensor. Once the sensor is activated, the sensor then detects any movement of a vehicle while the vehicle is turned off. Upon detecting that the vehicle is moving, power is applied by a controller to a motor operator to engage the electronic parking brake and thereby automatically applies the parking brake.

### CROSS-REFERENCE TO RELATED APPLICATION

This application claims priority to and the benefit of Korean Patent Application No. 10-2013-0021300 filed in the Korean Intellectual Property Office on Feb. 27, 2013, the entire contents of which are incorporated herein by reference.

### BACKGROUND OF THE INVENTION

(a) Field of the Invention

The present invention is related to an electronic parking brake for a vehicle that effectively prevents an accident from occurring due to unintended movement of a parked vehicle.

(b) Description of the Related Art

Recently, various different kinds of electronic braking devices have begun to be implemented in vehicles to aide in the prevention of vehicular accidents. For example, ABS (Anti-lock Brake System) is a system that prevents a wheel or tire from locking up during the braking, ESC (Electronic Stability Control) is a system that stabilizes the movement of the vehicle by generating braking force through hydraulic pressure when a vehicle is turning, and EPB (Electronic Parking Brake) is a system that electrically controls a parking brake.

An EPB system operates, in particularly, an electronic parking brake to prevent the vehicle from moving when the shift lever is in park and an EPB switch is in an ON position. However, when the EPB switch is turned off and a shift lever is in a Neutral state (N) the vehicle may still be moved when for example, the vehicle is on a hill or another vehicle bumps into the vehicle that is in Neutral

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a vehicle having an electronic parking brake having advantages of improving a parking stability of a vehicle by detecting a movement of a vehicle and operating an electronic parking brake automatically upon detecting such movement when the vehicle is parked.

A vehicle having an electronic parking brake according to an exemplary embodiment of the present invention may include a movement detecting sensor that is configured to detect a movement of a vehicle, a sensor power supplier that is configured to supply the movement detecting sensor with power once the vehicle is turned off, a parking brake that is disposed to fix a wheel of the vehicle, a motor operator that is configured to operate the parking brake, a controller that is configured to control the movement detecting sensor, the sensor power supplier, the parking brake, and the operator, and a controller power supplier that supplies the controller with power when the controller determines that the vehicle is moving based on the operation of the movement detecting sensor and the vehicle is currently turned off.

More specifically, the controller may use the power that is supplied from the controller power supplier to operate the parking brake when the vehicle is turned off.

Additionally, the movement detecting sensor may be a gyro sensor. The sensor power supplier may turn on or off the movement detecting sensor by comparing a predetermined voltage for an ignition-On state with a stand-by voltage (B+) of a battery. The sensor power supplier may likewise turn off the movement detecting sensor once the vehicle has been turned back on.

In some exemplary embodiments of the present invention, the controller may be configured to operate the parking brake, only when the vehicle is in neutral (N), drive (D), or a reverse (R) mode and the vehicle is turned off.

Furthermore, the operator may be embodied as a motor driver that utilizes a motor to be operated.

As described above, the electronic parking brake according to an exemplary embodiment of the present invention effectively prevents a movement of a vehicle when a shift lever is in a neutral or a drive mode and a vehicle is turned off. Also, a power is supplied to a movement detecting sensor is able to be applied to the sensor while the vehicle is off by a battery in order to effectively detect the movement of the vehicle while the vehicle ignition is off. Furthermore, when it is determined by the movement detecting sensor that the vehicle is off and is moving, the power is then supplied to the controller to control the electronic parking brake.

### BRIEF DESCRIPTION OF THE DRAWINGS

FIG. 1 is a schematic diagram of a vehicle having an electronic parking brake according to an exemplary embodiment of the present invention.

FIG. 2 is a schematic circuit diagram of an electronic parking brake unit according to an exemplary embodiment of the present invention.

FIG. 3 is a flowchart showing a control method of a vehicle having an electronic parking brake according to an exemplary embodiment of the present invention.

### DESCRIPTION OF SYMBOLS

100: movement detecting sensor

110: sensor power supplier

120: parking brake

130: motor operator

140: controller power supplier

150: controller

200: comparator

210: motor driver

220: motor

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the below methods are executed by at least one controller or sensor. The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

An exemplary embodiment of the present invention will hereinafter be described in detail with reference to the accompanying drawings.

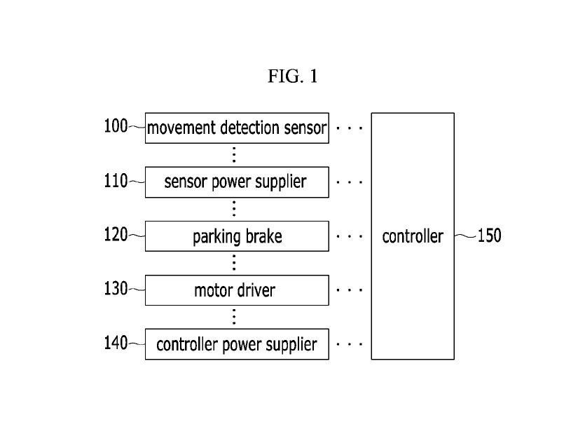

FIG. 1 is a schematic diagram of a vehicle having an electronic parking brake according to an exemplary embodiment of the present invention. Referring to FIG. 1, a vehicle includes a movement detecting sensor 100, a sensor power supplier 110, a parking brake 120, a motor operator 130, a controller power supplier 140, and a controller 150.

The movement detecting sensor 100 may be embodied as a gyro sensor that is configured to detect the movement of the vehicle. Additionally, the sensor power supplier 110 is configured to supply the movement detecting sensor 100 with power when the vehicle is turned off. As such, the sensor power supplier is triggered to turn on a supply power to the sensor 100 only once the vehicle is turned off.

Additionally, in the exemplary embodiment of the present invention, the parking brake 120 fixes a drive wheel of a vehicle and is operated by the motor operator 130. The motor operator 130 may be controlled by the controller 150 to operate the parking brake 120 accordingly. Accordingly, if the movement detecting sensor 10 detects that the vehicle is moving while the vehicle is turned off, the controller power supplier 140 is then configured to supply the controller 150 with power so that it can activate the parking brake 120 automatically.

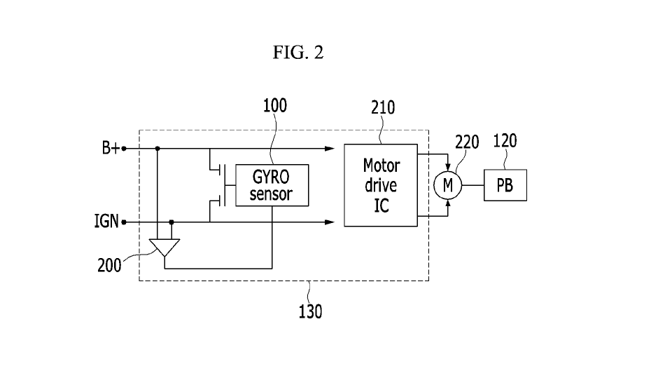

FIG. 2 is a schematic circuit diagram of an electronic parking brake unit according to an exemplary embodiment of the present invention. Referring to FIG. 2, an electronic parking brake unit includes a motor operator 130 and a parking brake 120, and a comparator 200. Furthermore, a movement detecting sensor 100, a motor driver 210, and a motor 220 are disposed in the motor operator 130. The comparator 200 is configured to compare B+ with IGN. Here, B+ denotes a standby voltage of a battery, and IGN denotes an ignition-On voltage that is supplied from a battery when the vehicle is turned on.

In an exemplary embodiment of the present invention, power may be supplied to the movement detecting sensor 100 depending on a determination from the comparator 200. More particularly, the comparator 200 compares the B+ voltage and IGN voltage to determine whether the vehicle ignition is currently turned on or turned off. And, when it is determined that the vehicle is off, power is supplied to the movement detecting sensor 100 to activate the movement detecting sensor 100. Subsequently, if the vehicle begins to move, the movement detecting sensor 100 supplies the motor driver 210 with power to operate the motor 220 and engage the parking brake 120. Once the vehicle is turned back on, the power is again disconnected from the movement detecting sensor 100 so that the parking brake 120 is not engaged inappropriately.

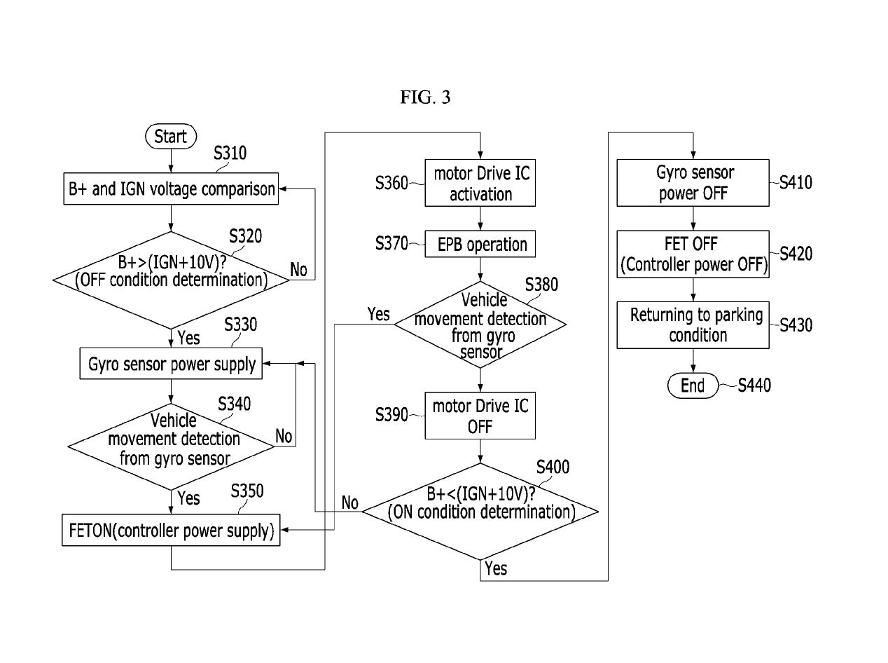

FIG. 3 is a flowchart showing a control method of a vehicle having an electronic parking brake according to an exemplary embodiment of the present invention. Referring to FIG. 3, a control is started in S300, and B+ voltage is compared with IGN voltage in S310. When it is determined that the B+ voltage is larger than IGN+10 voltage in S320, it is determined that the vehicle is currently turned off, and power is supplied to the movement detecting sensor 100 in S330.

The movement detecting sensor 100 then monitors the vehicle to detect any movement of the vehicle in S340. If it is determined that the vehicle is not moving, it is returned to a S330. However, if it is determined that the vehicle is moving, a Field-effect-transistor (FET), for example, is turned on in S350. Accordingly, power is supplied to the controller 150 as a result, and the motor driver 210 (drive IC) is activated in S360, the motor 220 is operated in S370, and an electronic parking brake 120 (EPB) is engaged.

Accordingly, the movement of the vehicle is detected by the movement detecting sensor 100 in S380 and when it is determined that the vehicle is moving, S350 is performed. On the contrary, when it is determined that the vehicle is not moving, the motor driver 210 (drive IC) is turned off in S390, and when it is determined that B+ voltage is less than IGN+10 voltage in S400, the sensor is powered off in S410. On the contrary, when it is determined that the B+ voltage is greater than IGN+10 voltage, the sensor is supplied with power in S330.

As such, the power that is supplied to the movement detecting sensor 100 is turned off in S410, and the power that is supplied to the controller 150 is turned off by turning off a field-effect transistor for example in S420, and the vehicle is then returned to a parked state in S430, and a control is ended in S440.

Additionally, the controller 150 according to an exemplary embodiment of the present invention can perform a predetermined algorithm or program for controlling all controllable elements.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electronic parking brake for a vehicle, comprising:
a movement detecting sensor that is configured to detect a movement of a vehicle when the vehicle is turned off;
a sensor power supplier that is configured to supply the movement detecting sensor with power once the vehicle is turned off;
a parking brake that is disposed to fix a wheel of the vehicle upon being engaged;
a motor operator that is configured to operate the parking brake;
a controller that is configured to control the operation of the movement detecting sensor, the sensor power supplier, the parking brake, and the operator; and
a controller power supplier that supplies the controller with power, upon detecting that the vehicle is moving while the vehicle is turned off.

2. The vehicle having an electronic parking brake of claim 1, wherein the controller uses the power that is supplied from the controller power supplier to operate the parking brake when the vehicle is turned off.

3. The vehicle having an electronic parking brake of claim 1, wherein the movement detecting sensor is a gyro sensor.

4. The vehicle having an electronic parking brake of claim 1, wherein the sensor power supplier turns on and off the movement detecting sensor based on a comparison of a predetermined voltage for an ignition-On with a stand-by voltage (B+) of a battery.

5. The vehicle having an electronic parking brake of claim 4, wherein the sensor power supplier turns off the movement detecting sensor when the vehicle is turned on.

6. The vehicle having an electronic parking brake of claim 1, wherein the controller operates the parking brake, only when the vehicle is in neutral (N), drive (D), or reverse (R) and the vehicle is turned off.

7. The vehicle having an electronic parking brake of claim 1, wherein the operator is a motor driver that utilizes a motor to be operated.

8. A method for operating an electric parking brake of a vehicle comprising:
determining, by a controller, whether the vehicle is on or off;
in response to determining that the vehicle is turned off, supplying power to a sensor;
detecting, by the sensor, any movement of a vehicle while the vehicle is turned off;
upon detecting that the vehicle is moving, applying power by a controller to a motor operator to engage the electronic parking brake.

9. The method of claim 8, wherein when the controller determines that the vehicle is on, power is not supplied to the sensor.

10. The method of claim 8, wherein the parking brake is engaged only when the vehicle is in neutral (N), drive (D), or reverse (R) and the vehicle is turned off.

11. The method of claim 8, wherein once the vehicle is turned off, power is not supplied to the controller until the sensor detects that the vehicle is moving.

12. A non-transitory computer readable medium containing program instructions executed by a controller, the computer readable medium comprising:
program instructions that determine whether the vehicle is on or off;
program instructions that supply power to a sensor in response to determining that the vehicle is turned off;
program instructions that apply power to a motor operator to engage the electronic parking brake upon receiving a signal from the sensor indicating that the vehicle is moving.

13. The non-transitory computer readable medium of claim 12, wherein when program instructions determine that the vehicle is on, power is not supplied to the sensor.

14. The non-transitory computer readable medium of claim 12, wherein the program instruction engage the parking brake only when the vehicle is in neutral (N), drive (D), or reverse (R) and the vehicle is turned off.

15. The non-transitory computer readable medium of claim 12, wherein once the vehicle is turned off, power is not supplied to the controller until the sensor detects that the vehicle is moving.
